(19) United States
(12) Patent Application Publication
(10) Pub. No.: US 2024/0059334 A1
(43) Pub. Date: Feb. 22, 2024

(54) Vessel Cart and Vessel Assembly Having Same

(71) Applicant: Sunflower Therapeutics, PBC, Hingham, MA (US)

(72) Inventors: Flora Peiying Liu, Somerville, MA (US); Marc Miller Graham, Somerville, MA (US)

(21) Appl. No.: 18/452,812

(22) Filed: Aug. 21, 2023

Related U.S. Application Data
(60) Provisional application No. 63/399,925, filed on Aug. 22, 2022.

(51) Int. Cl. B62B 3/10; B62B 3/04; B62B 5/04; B62B 5/06; B65D 25/20; B65D 53/02

(52) U.S. Cl. CPC B62B 3/104; B62B 3/04; B62B 5/0433; B62B 5/061; B65D 25/20; B65D 53/02; B62B 2202/02; B62B 2203/44

(57) ABSTRACT

Described herein is a vessel cart including a base, a stand and a clamp. The base is configured to abut a lower portion of a vessel and hold the vessel upright when the vessel is loaded to the vessel card. The stand is connected to or formed with the base. The clamp is connected to the stand and configured to selectively grip an upper portion of the vessel. The clamp is also configured to open and close in a plane substantially parallel to a first surface of the base facing the clamp to allow the vessel to move laterally or radially relative to the clamp when the vessel is being loaded to the vessel cart or unloaded from the vessel cart.

### CROSS REFERENCE TO RELATED APPLICATIONS

The present application claims priority to U.S. Provisional Patent Application No. 63/399,925 filed Aug. 22, 2022 titled “Vessel Cart and Vessel Assembly Having Same”. The disclosure of the application is incorporated herein for all purposes by reference in its entirety.

### TECHNICAL FIELD

The present disclosure generally relates to vessel carts for holding and transporting bioreactors and to vessel assemblies having vessel carts.

### BACKGROUND

Bioreactors are vessels configured to provide an effective environment for enzymes or whole cells to transform biochemicals into products. They are commonly used in producing biopharmaceuticals, vaccines, and other biological products. To ensure the quality of the production, bioreactors must be properly handled, cleaned, sterilized and safely guarded. Since a bioreactor may have a size ranging from liters, tens of liters to hundreds of liters or more, and may weigh tens, hundreds, thousands or more pounds, there is a need for a vessel cart that can hold and transport a vessel and that can be integrated into a vessel assembly suitable for use in sterilization and/or other biological processes.

### SUMMARY

The present disclosure provides a vessel cart that can be used to secure, hold and/or transport a vessel and a vessel assembly that can be used to hold and secure a vessel during use or assembling.

In various exemplary embodiments, the present disclosure provides a vessel cart. The vessel cart includes a base configured to abut a lower portion of a vessel and hold the vessel upright when the vessel is loaded to the vessel card. The vessel cart also includes a stand connected to or formed with the base, and a clamp connected to the stand and configured to selectively grip an upper portion of the vessel. The clamp is configured to open and close in a plane substantially parallel to a first surface of the base facing the clamp to allow the vessel to move laterally or radially relative to the clamp when the vessel is being loaded to the vessel cart or unloaded from the vessel cart. This reduces a lifting height required for loading the vessel to the vessel cart or unloading the vessel from the vessel cart.

In some exemplary embodiments, the base includes a restriction member configured to limit movement of the lower portion of the vessel on the base. The restriction member may be a raised rim on the first surface of the base facing the clamp, a dent recessed from the first surface of the base facing the clamp, an opening formed on the first surface of the base facing the clamp, or any combination thereof. In some exemplary embodiments, the base includes a first base member, and a second base member disposed below and connected to the first base member. The first base member has an opening to allow the lower portion of the vessel to pass through and seat on the second base member. In an exemplary embodiment, a rib disposed or formed on a surface of the second base member facing the first base member and an edge of the opening of the first base member collectively limits movement of the lower portion of the vessel on the base when the vessel is loaded to the vessel cart.

In some exemplary embodiments, the stand includes a first bar and a second bar spaced apart from each other, and optionally or additionally, a cross member connected to or formed with upper portions of the first and second bars. The first and second bars may be substantially perpendicular to the first surface of the base facing the clamp, and the clamp may be connected (permanently or removably) to the cross member of the stand.

In some exemplary embodiments, the clamp includes first, second and third clamp members. The first clamp member is connected to the stand. The second clamp member is pivotally connected to the first clamp member and rotatable with respect to the first clamp member in the plane substantially parallel to the first surface of the base. The third clamp member is disposed at the first or second clamp member and configured to selectively lock or unlock the second clamp member with respect to the first clamp member. In some exemplary embodiments, the clamp is configured to facilitate mounting of a headplate on the clamp. For instance, the clamp may include a plurality of fastening members each extending upward for connecting the headplate with the clamp.

In some exemplary embodiments, the vessel cart includes a plurality of wheels connected to the base at a side of the base facing away from the clamp to facilitate moving of the vessel cart. The plurality of wheels may include one or more fixed wheels disposed at a rear side of the vessel cart, and one or more swivel v-groove track wheels disposed at a front side of the vessel cart.

In some exemplary embodiments, the vessel cart includes a brake connected to the stand or the base and configured to selectively lock or unlock the vessel cart. The brake may be a foot brake connected to the base at the side of the base facing away from the clamp.

In some exemplary embodiments, the vessel cart includes one or more handles connected to or integrally formed with an upper portion of the stand to facilitate maneuvering of the vessel cart. The one or more handles may include a first pair of handles extending toward a rear side of the vessel cart, and/or a second pair of handles extending toward a front side of the vessel cart. In an exemplary embodiment, the handles of the second pair of handles are longer than the handles of the first pair of handles, and/or spaced apart from each other in a greater distance than the handles of the first pair of handles.

In various exemplary embodiments, the present disclosure provides a vessel cart. The vessel cart includes a stand having a first bar and a second bar spaced apart from each other. Each of the first and second bars includes a lower portion and an upper portion. The vessel cart also includes a first pair of handles, with one connected to or integrally formed with the upper portion of the first bar and the other connected to or integrally formed with the upper portion of the second bar. The vessel cart further includes a base connected to the lower portions of the first and second bars. The base includes a first base member and a second base member disposed below the first base member. The first base member has an opening facing upward and configured to receive a lower portion of a vessel, and the second base member is connected to the first base member and configured to hold the vessel upright. In addition, the vessel cart includes a clamp and a plurality of wheels. The clamp is connected to the stand and configured to selectively grip an upper portion of the vessel, and the plurality of wheels is connected to a side of the base facing away from the clamp to facilitate moving of the vessel cart.

In some exemplary embodiments, the vessel cart further includes a second pair of handles, with one connected to or integrally formed with the upper portion of the first bar and the other connected to or integrally formed with the upper portion of the second bar. In such embodiments, each handle in the first pair of handles may extend toward a rear side of the vessel cart, and/or each handle in the second pair of handles may extend toward a front side of the vessel cart.

In various exemplary embodiments, the present disclosure provides a vessel assembly. The vessel assembly includes a vessel cart disclosed herein and a headplate configured to be mounted on the clamp of the vessel cart. The clamp of the vessel cart may include a plurality of fastening members extending upward, and the headplate may be fastened to the clamp by a plurality of knobs, each tighten on a corresponding fastening member in the plurality of fastening members. The headplate may include a groove formed at a lower side of the headplate to accommodate a sealing member, such as an O-ring or a gasket.

In some exemplary embodiments, the vessel assembly includes a vessel configured to be loaded into the vessel cart. The vessel may be a reaction vessel for biomaterial processing, and/or may have a sustainably cylindrical shape. In some exemplary embodiments, the vessel has a height ranging from 10 inches to 60 inches, and/or a nominal diameter ranging from 5 inches to 20 inches.

In some exemplary embodiments, the vessel assembly has a width ranging from 12 inches to 24 inches, a height ranging from 22 inches to 42 inches, and a depth ranging from 19 inches to 36 inches. The vessel assembly is configured to fit in a sink, a dishwasher, an autoclave or an upstream processing module of a biomanufacturing system.

### BRIEF DESCRIPTION OF THE DRAWINGS

The foregoing summary, as well as the following detailed description of embodiments of the vessel cart and vessel assembly, will be better understood when read in conjunction with the appended drawings of exemplary embodiments. It should be understood, however, that the disclosure is not limited to the precise arrangements and instrumentalities shown.

In the drawings:

FIG. 1 is a perspective view illustrating a vessel cart in accordance with an exemplary embodiment of the present disclosure;

FIG. 2 is a perspective view illustrating the vessel cart of FIG. 1 with a vessel being loaded to the vessel cart;

FIG. 3 is a perspective view illustrating the vessel cart of FIG. 1 with a loaded vessel;

FIG. 4 is a sectional view illustrating a lower portion of the vessel cart of FIG. 1;

FIG. 5 is a perspective view illustrating a vessel assembly in accordance with an exemplary embodiment of the present disclosure;

FIG. 6 is a sectional view illustrating an upper portion of the vessel assembly of FIG. 5;

FIG. 7 is a perspective view illustrating a vessel cart in accordance with another exemplary embodiment of the present disclosure;

FIG. 8 is a sectional view illustrating the vessel cart of FIG. 7; and

FIG. 9 is a perspective view illustrating the vessel cart of FIG. 7.

### DETAILED DESCRIPTION

In certain embodiments, the present disclosure provides a vessel cart for securing, holding and/or transporting a vessel, such as a reactor vessel for producing biopharmaceuticals and vaccines. The vessel cart generally includes a base and a clamp configured to allow the vessel to move lateral or radial with respect to the clamp when the vessel is being loaded to or unloaded from the vessel cart. As a result, loading and unloading of the vessel can be done easily with no or little heavy lift. In some embodiments, the clamp can be separated from other components of the vessel cart to allow thorough cleaning of the clamp and/or other components of the vessel cart.

In certain embodiments, the present disclosure provides a vessel assembly for holding and securing a vessel during use or assembling, such as during cleaning, sterilization, or manufacturing of biopharmaceuticals and vaccines. A vessel assembly generally includes a vessel cart of the present disclosure and a headplate configured to be mounted on the clamp of the vessel cart. In some embodiments, a vessel assembly also includes a vessel held and secured by the vessel cart and/or headplate. The entire vessel assembly can be sterilized as a single unit, for instance, by autoclaving. The sterilized assembly can be placed, also as a single unit, in a processing module, such as an upstream processing module of a biomanufacturing system, for the production of the desired biological products.

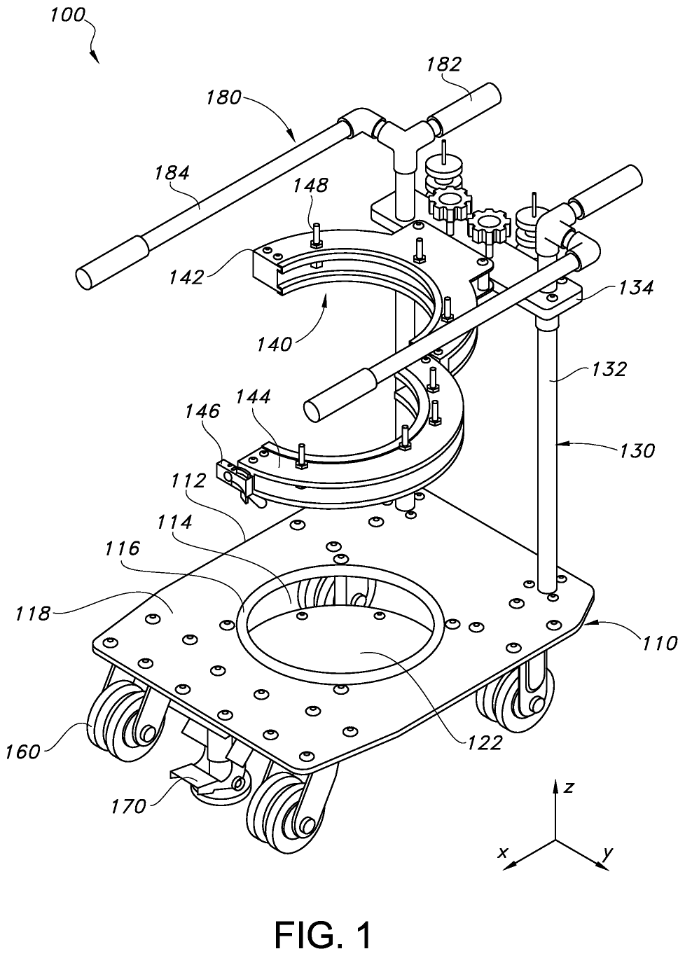

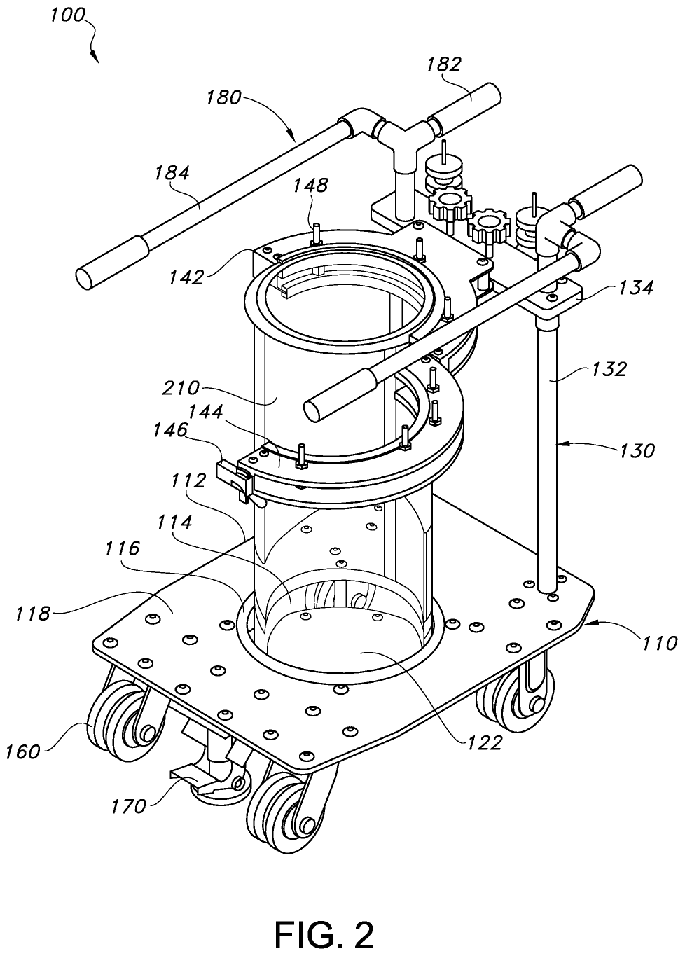

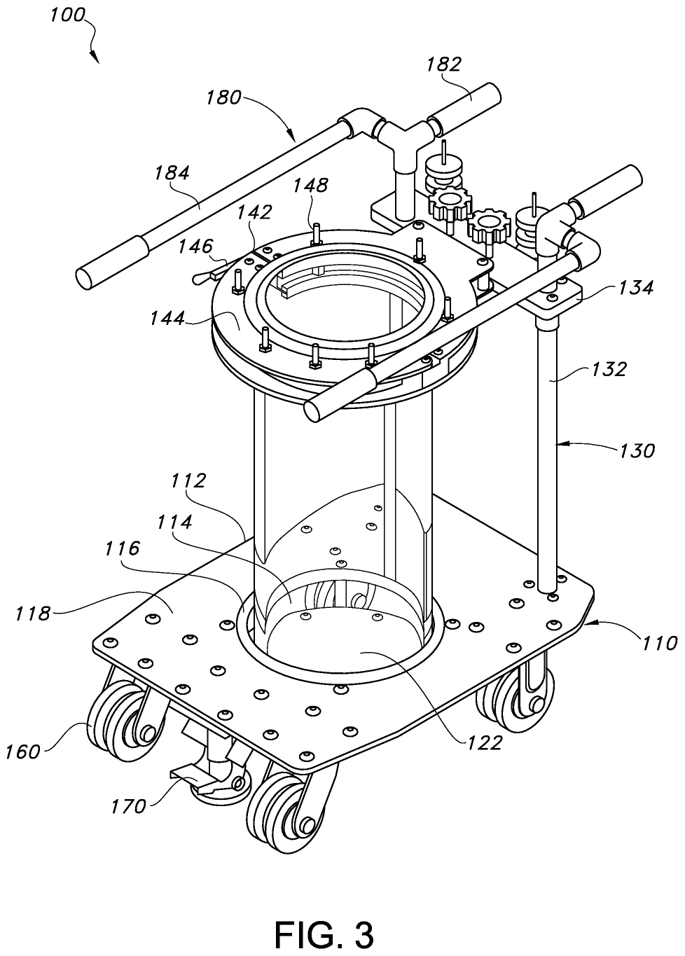

Referring to the drawings in detail, wherein like reference numerals indicate like elements throughout, there is shown in FIGS. 1-4, an exemplary vessel cart, generally designated 100, in accordance with some exemplary embodiments of the present disclosure. The vessel cart 100 can be used to secure, hold and/or transport a vessel 210. The vessel cart 100 generally includes a base 110, a stand 130, and a clamp 140. The base 110 is configured to abut a lower portion of the vessel. The stand 130 is connected to or formed with the base 110. The clamp 140 is connected to or formed with the stand 130, and configured to hold an upper portion of the vessel.

In some embodiments, the base 110 includes a first base member 112 and a second base member 122 disposed below and connected to the first base member 112. The first and second base members 122 can have any suitable shapes, including but not limited to square, rectangular, circular or oblong shapes. By way of example, the first base member 112 is shown to be substantially rectangular and the second base member 122 is shown to be substantially circular. Also, the first and second base members 122 can be substantially planar or non-planar. Preferably, at least a portion of the surface 118, e.g., the surface of the base that faces the clamp 140, is substantially planar. By way of example, each of the first and second base members 122 is shown to be substantially planar and similar to a flat plate or the like.

The first base member 112 is formed with an opening 114 to allow a lower portion of the vessel 210 to pass through. The opening 114 can have any suitable sizes or shapes, including but not limited to a square, a circle, an oval, an oblong, or the like. Preferably, the opening 114 is shaped and/or sized in accordance with the shape and size of the vessel 210 to be loaded. For instance, in an embodiment where the vessel 210 is cylindrical, the opening 114 may be substantially circular. In some embodiments, the first base member 112 includes a strengthening member 116 along a portion or the entire periphery of the opening 114 to enhance the strength of the opening 114. The strengthening member 116 may be a flange, a ridge, a rim, a collar, a lip, an indent, or the like.

Once the lower portion of the vessel 210 passes through the opening of the first base member 112, the vessel 210 seats on the second base member 122. For instance, the vessel 210 seats on a surface 124 of the second base member 122 that faces the first base member 112. Together, the first base members 112 and second base members 122 hold the vessel 210 upright, e.g., in a direction substantially parallel to the z-direction in FIG. 1.

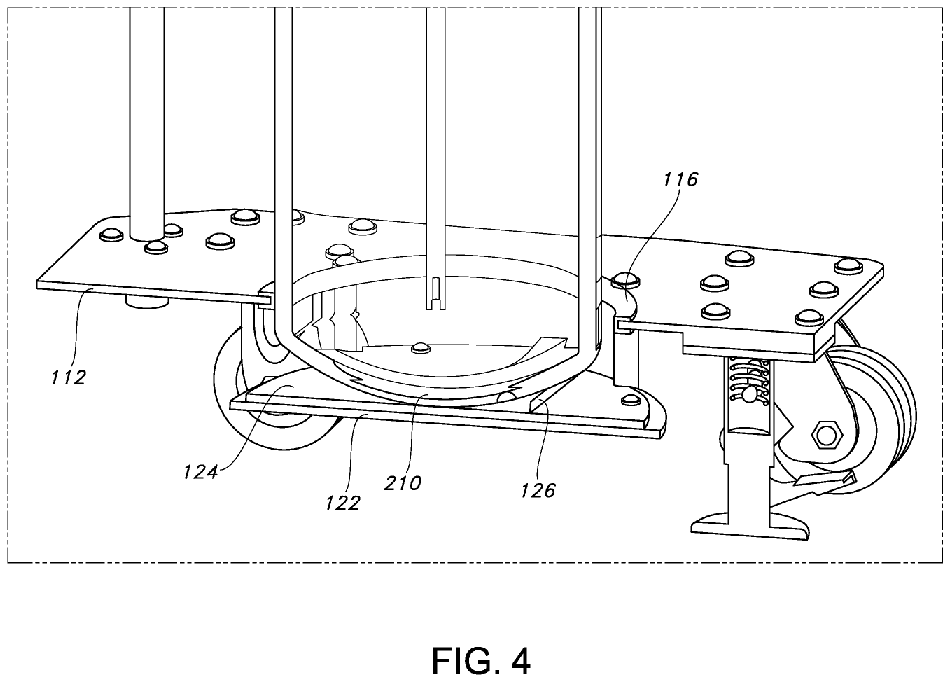

In some embodiments, the base 110 includes one or more restriction members to help locate the vessel 210, limit movement of the lower portion of the vessel 210 on the base, support a bottom of the vessel 210, and/or assist in holding the vessel 210 upright. A restriction member can be a raised rim, a rib, a flange, a recess, a dent, an opening, or the like, and can be disposed or formed on the first base member 112 or the second base member 122. As a non-limiting example, FIG. 4 illustrates a rib 126 disposed or formed on the surface 124 of the second base member 122. The rib can have any suitable shapes and sizes. For instance, the rib can be substantially straight, partially straight/curved, or substantially curved. When the vessel 210 rests on the second base member 122, the rib abuts the vessel 210 so that the vessel 210 is snug to an edge (e.g., a portion of the periphery or the strengthening member 116 at a portion of the periphery) of the opening 114. As such, the lower portion of the vessel 210 is restricted from moving sideways (e.g., in the x-y plane in FIG. 1) on the base once it is loaded to the vessel cart 100.

While FIGS. 1-4 illustrate that the base 110 includes the first base members 112 and second base members 122, it should be noted that this is by way of example and is non-limiting. To abut and hold the vessel 210 upright when the vessel 210 is loaded to the vessel cart 100, the base 110 can have various other configurations. For instance, in an embodiment, the base 110 has a single base member with a surface facing the clamp 140 to abut the lower portion of the vessel 210, and one or more restriction members disposed or formed on the single base member to help locate the vessel 210, limit movement of the lower portion of the vessel 210 on the base 110, and/or assist in holding the vessel 210 upright. In another embodiment, the base 110 has more than two base members.

The stand 130 is connected to or formed with the base 110. The stand 130 can be a rod, a rack, a support, a platform or the like. As a non-limiting example, it is illustrated that the stand 130 includes a first bar and a second bar, such as bar 132. The lower portions of the first and second bars are connected to the first base member 112, for instance, by welding, fastening or any other suitable means. The first and second bars can be but do not have to be identical or symmetrical to each other. The first and second bars can also be hollow, partially hollow, or solid. Further, the first and second bars can be perpendicular or oblique to the base 110 (e.g., to the surface 118 of the first base member 112) or the clamp 140. Preferably, the first and second bars are spaced apart from each other, for instance, in the y-direction in FIG. 1. In some embodiments, the stand 130 also includes a cross member 134 that is connected to or integrally formed with upper portions of the first and second bars.

The clamp 140 is connected to or formed with the stand 130. In an embodiment, the clamp 140 is detachably connected to the stand 130, for instance, by bolts and nuts or the like, so that when needed, the clamp 140 can be separated from other components of the vessel cart 100 when needed or desired. When connected to the stand 130, the clamp 140 is fixed on the stand 130 to reduce or minimize vibration of the vessel 210. In another embodiment, the clamp 140 is fixedly or permanently connected to the stand 130 (e.g., the cross member 134 of the stand 130), for instance, by welding or the like. In a further embodiment, the clamp 140 is integrally formed with the stand 130.

The clamp 140 is configured to open and close in a plane substantially parallel to the surface 118 of the base 110 that faces the clamp 140. In the embodiment illustrated in FIG. 1, the surface 118 of the base 110 is substantially horizontal, and accordingly, the clamp 140 is configured to open and close substantially horizontally or along an axis substantially parallel to the z-direction in FIG. 1. The clamp 140 can have a variety of configurations. For instance, the clamp 140 can be configured similarly to pipe clamps, hose clamps, loop clamps, shaft collars or the like. Preferably, the clamp 140 is configured with an interior shaped and/or sized in accordance with an exterior of the vessel 210 to be loaded to ensure proper gripping of the vessel 210. For instance, in an embodiment where the vessel 210 is cylindrical, the clamp 140 is configured to have a substantially circular interior periphery.

The clamp 140 can be made of 1 piece, 2 pieces, 3 pieces, 4 pieces, or more than 4 pieces. Any 2 pieces of the clamp 140 can be interlocked with each other by any suitable locking means such as screws, pins, bolts, latches, clasps, clips, springs or the like. As a non-limiting example, in an embodiment, the clamp 140 includes a first clamp member 142, a second clamp member 144, and a third clamp member 146. The first clamp member 142 is connected to the stand 130, e.g., the cross member of the stand 130. The second clamp member 144 is pivotally connected to the first clamp member 142 so that it is rotatable with respect to the first clamp member 142 in the plane substantially parallel to the surface 118 of the base 110. The third clamp member 146 is disposed at the first clamp member 142 or second clamp member 144 and configured to selectively lock or unlock the second clamp member 144 with respect to the first clamp member 142.

The pivotal connection of the first and second clamp members 142 allows the clamp 140 to open and close in the plane substantially parallel to the surface 118 of the base 110. The opening and closing of the clamp 140 in this manner allows the vessel 210 to move laterally or radially relative to the clamp 140 when it is being loaded to the vessel cart 100 or unloaded from the vessel cart 100. This reduces or minimizes the height of heavy lifting and thus reduces the work required to load and unload the vessel 100.

When the clamp 140 is closed, and in particular, when the first clamp members 142 and second clamp members 144 are locked by the third clamp member 146, the clamp 140 grips an upper portion of the vessel 210. Together with the base 110, the clamp 140 holds the vessel 210 in a position (e.g., an upright position) desired for transporting the vessel 210, cleaning, sterilization, or other manufacturing processing.

In some embodiments, the clamp 140 is configured to facilitate mounting of one or more other components. For instance, in an embodiment, the clamp 140 includes a plurality of fastening members 148 each extending upward for connecting one or more other components (e.g., the headplate disclosed herein) with the clamp 140. The plurality of fastening members 148 can include 2, 3, 4, 5, 6, 7, 8 or more than 8 fastening members. The plurality of fastening members 148 can also be distributed substantially evenly or non-evenly along the perimeter of the clamp 140. By way of example, 6 substantially evenly distributed fastening members are illustrated.

In some embodiments, the vessel cart 100 includes additional, optional or alternative components. For instance, as a non-limiting example, in some embodiments, the vessel cart 100 includes a plurality of wheels 160 to facilitate moving of the vessel cart 100. The plurality of wheels may be connected to the base 110 (e.g., the first base member 112 of the base 110) at a side of the base facing away from the clamp 140. The plurality of wheels can be any suitable wheels and can be disposed in any suitable positions. For instance, the plurality of wheels may include one or more fixed wheels disposed at a rear side of the vessel cart 100 (e.g., the side adjacent to the first and second bars of the stand 130), and/or one or more swivel v-groove track wheels disposed at a front side of the vessel cart 100 (e.g., the side away from the first and second bars of the stand 130). In an embodiment, two fixed wheels and two swivel v-groove track wheels are provided for maneuverability. Preferably, the wheels are large enough to roll over cables and/or uneven surfaces, and/or are routable along angle-iron tracks. Examples of wheels include but are not limited to 4 inch stainless steel 90° v-groove track wheels.

As another non-limiting example, in some embodiments, the vessel cart 100 includes a brake 170 to selectively lock or unlock the movement of the vessel cart 100. When the brake 170 is locked, the vessel cart 100 is prevented from moving translationally or rotationally. The brake 170 can be any suitable type of brakes, and can be connected to the stand 130 or the base 110 at any suitable positions. For instance, the brake 170 may be a foot brake connected to the base 110 at the side of the base facing away from the clamp 140. In an embodiment, the brake 170 is a user-friendly brake, such as a kick break that can be released simply by foot. Other than the brake 170, the vessel cart 100 may include one or more additional brakes, locks or other fastening means, if additional position fixing and/or damping is desired. For instance, the vessel cart 100 may include an additional fastening means that locks the vessel cart 100 to a frame of an upstream processing module of a biomanufacturing system.

As a further non-limiting example, in some embodiments, the vessel cart 100 includes one or more handles 180 to facilitate maneuvering of the vessel cart 100. The one or more handles may be connected to or formed with an upper portion of the stand 130, e.g., connected to or formed with an upper portion of the first or second bar of the stand 130. A handle may extend toward a rear or front side of the vessel cart 100 for ease of positioning (e.g., pushing, rotating) the vessel cart 100. By way of example, FIG. 1 illustrates a first pair of handles 182 extending toward a rear side of the vessel cart 100 and a second pair of handles 184 extending toward a front side of the vessel cart 100. Two sets of handles make the moving and positioning of the vessel easier and more convenient. The first pair of handles 182 are spaced apart from each other. Similarly, the second pair of handles 184 are generally spaced apart from each other. The second pair of handles 184 may be longer than the first pair of handles 182. In an embodiment, the spacing (e.g., a distance) between the second pair of handles 184 is greater than the spacing between the first pair of handles 182 so that the second pair of handles 184 would not interfere with the loading and unloading of the vessel or installation of other components such as the headplate disclosed herein.

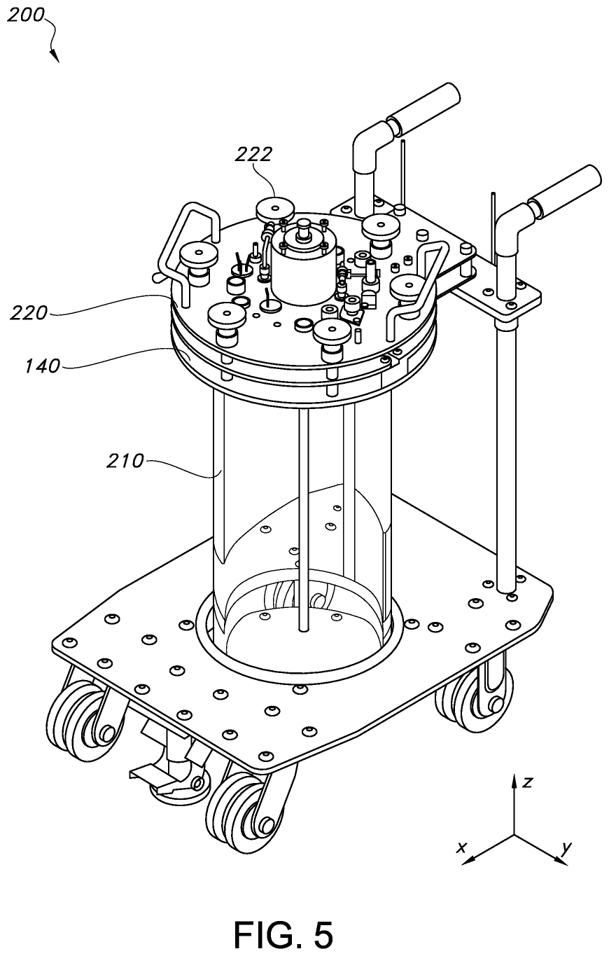

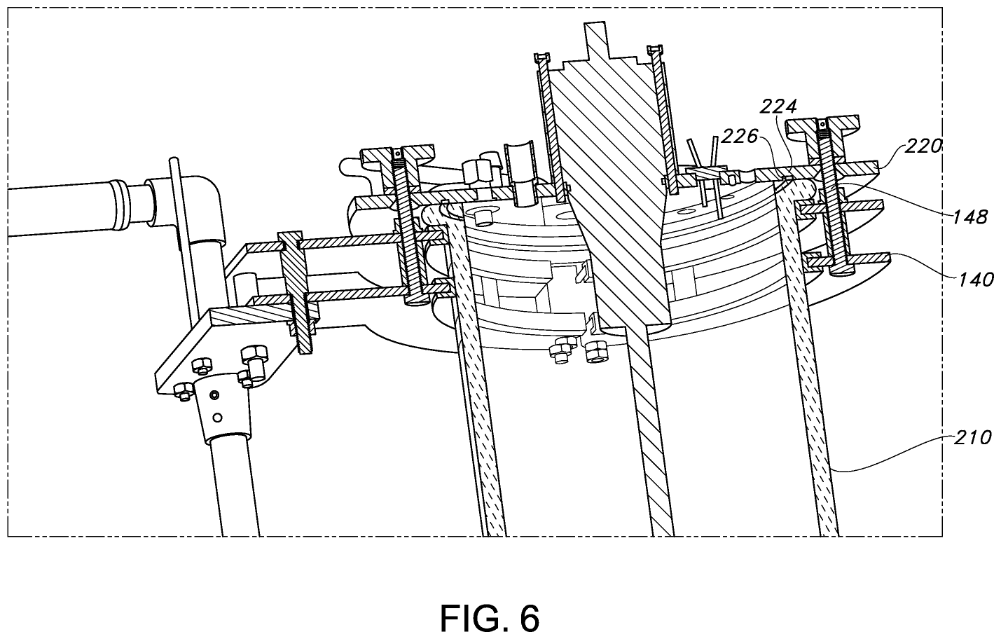

Referring now to FIGS. 5 and 6, there is shown an exemplary vessel assembly, generally designated 200, in accordance with some exemplary embodiments of the present disclosure. The vessel assembly 200 includes a vessel cart, e.g., the vessel cart 100, and a headplate 220 configured to be mounted on the clamp of the vessel cart. In some embodiments, the vessel assembly 200 also includes a vessel, e.g., the vessel 210, configured to be loaded into the vessel cart. The headplate 220 is configured to seal the vessel and to provide ports for access to the interior of the vessel.

The vessel 210 can be any suitable type of vessels. Non-limiting examples of the vessel include bioreactor vessels used in biological processes. The vessel can be made of glass, stainless steel or other materials. The vessel can also be a single use or reusable. Further, the vessel can have a variety of shapes and sizes. For instance, the vessel may be a reaction vessel of a cylindrical shape. The vessel may have a height ranging from 10 inches to 20 inches, from 20 inches to 30 inches, from 30 inches to 40 inches, from 40 inches to 50 inches, from 50 inches to 60 inches, or greater than 60 inches. In an embodiment, the vessel may have a height of about 15 inches, about 20 inches, about 25 inches, about 30 inches, or about 35 inches. The vessel may have a nominal diameter ranging from 5 inches to 10 inches, from 10 inches to 15 inches, from 15 to 20 inches, or greater than 20 inches. The vessel may be configured to accommodate other components, such as those that allow for stirring, monitoring pressure, monitoring temperature, adding samples, and/or removing samples.

The headplate 220 is mounted on the clamp of the vessel cart through the plurality of fastening members 148. In an embodiment, a plurality of knobs 222 is provided to fasten the headplate 220 on the clamp. A knob 222 may be tightened on a fastening member 148, for instance, first by hand and then by an adjustable torque wrench. To help seal the vessel, in an embodiment, the headplate 220 is formed with a groove 224 at a lower side of the headplate 220 to accommodate a sealing member 226. The sealing member can be an O-ring, a gasket or the like.

In some embodiments, the vessel assembly 200 is configured to fit in a sink, a dishwasher, an autoclave or a module (e.g., an upstream processing module) of a biomanufacturing system. The vessel assembly 200 has a depth, a width and a height, e.g., the respective overall dimensions of the vessel assembly 200 in the x, y, z directions in FIG. 6. The depth of the vessel assembly 200 may range from 15 inches to 40 inches, from 40 inches to 80 inches, or greater than 80 inches. The width of the vessel assembly 200 may range from 10 inches to 30 inches, from 30 inches to 70 inches, or greater than 70 inches. The height of the vessel assembly 200 may range from 15 inches to 50 inches, from 50 inches to 100 inches, or greater than 100 inches. For instance, in an embodiment, the vessel assembly 200 has a depth ranging from 19 inches to 36 inches, a width ranging from 12 inches to 24 inches and a height ranging from 22 inches to 42 inches. In another embodiment, the vessel assembly 200 has a depth of about 27 inches, a width of about 18 inches and a height of about 33 inches. In a further embodiment, the vessel assembly 200 has a depth ranging from 35 inches to 70 inches, a width ranging from 20 inches to 60 inches and a height ranging from 40 inches to 80 inches.

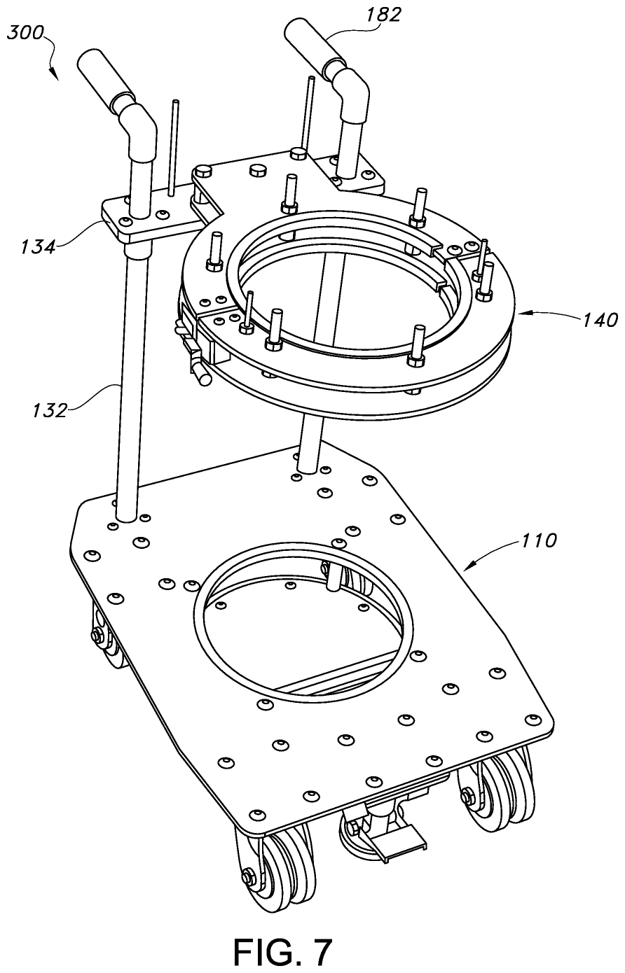

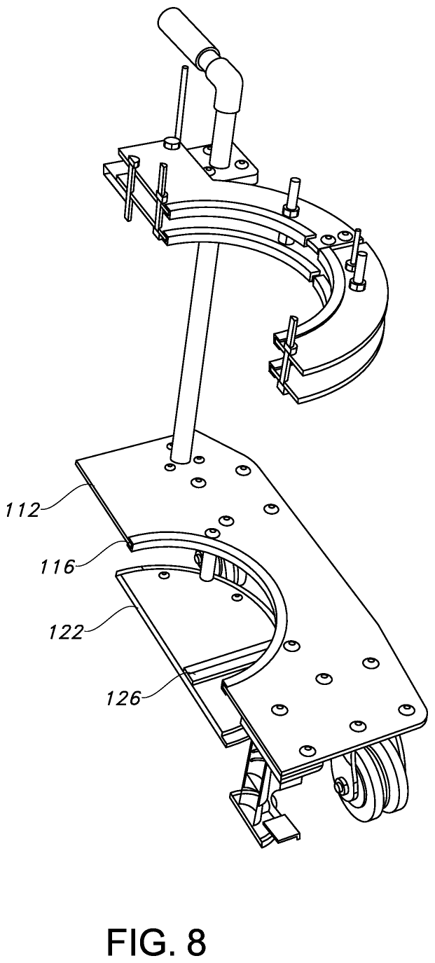

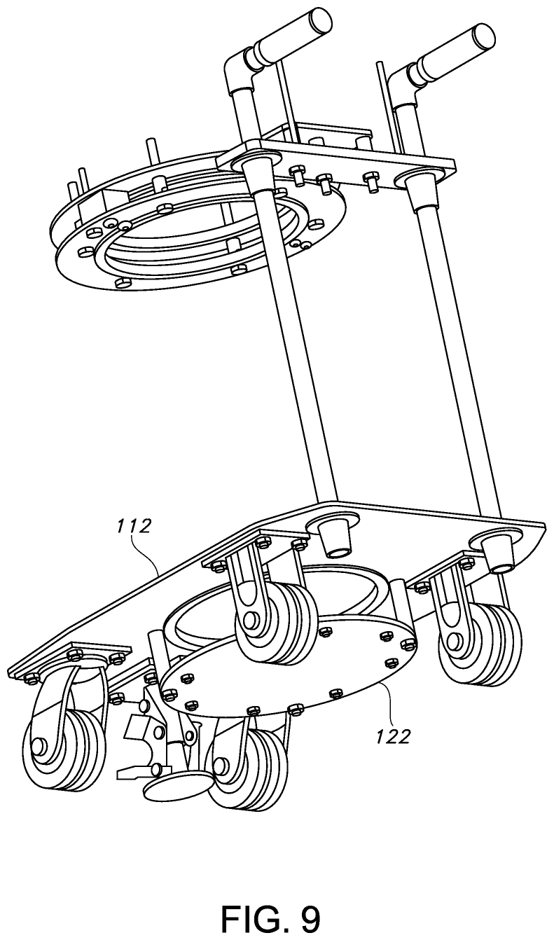

Referring to FIGS. 7-9, there is shown an exemplary vessel cart, generally designated 300, in accordance with some exemplary embodiments of the present disclosure. The vessel cart 300 is similar to the vessel cart 100 except that the vessel cart 300 does not include the second pair of handles 184. Like the vessel cart 100, the vessel cart 300 can be used to form a vessel assembly. For instance, the vessel cart 300 can replace the vessel cart 100 in the vessel assembly 200.

The vessel carts 100, 300 and the vessel assembly 200 disclosed herein have several advantages. For instance, the base with the first and second base members allows the vessel to seat on the relatively low second base member for enhanced stability, while creating a space below the first base member that permits the use of relatively larger wheels for enhanced mobility and/or maneuverability. The opening and closing of the clamp in the specific orientation reduces or minimizes the height of heavy lifting and thus reduces the work required to load and unload the vessel. The detachable connection of the clamp to the stand allows separation of the clamp from other components when desired (e.g., for thorough cleaning). The vessel cart is easily mobile for transporting the vessel for cleaning and/or assembly. Further, when coupled with a headplate, the vessel cart becomes an integral part of the vessel assembly and serves to secure and hold the vessel. The entire vessel assembly, as a single unit, can be easily placed in an autoclave for autoclaving and/or in a module (e.g., an upstream processing module) of a biomanufacturing system for processing biological materials.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “left” or “right”, “top” or “bottom”, “lower” or “upper”, “interior” or “exterior”, and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

As used herein, the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

What is claimed is:

1. A vessel cart comprising:
a base configured to abut a lower portion of a vessel and hold the vessel upright when the vessel is loaded to the vessel cart;
a stand connected to or formed with the base; and
a clamp connected to the stand and configured to selectively grip an upper portion of the vessel,
wherein the clamp is configured to open and close in a plane substantially parallel to a first surface of the base facing the clamp to allow the vessel to move laterally or radially relative to the clamp when the vessel is being loaded to the vessel cart or unloaded from the vessel cart.

2. The vessel cart of claim 1, wherein the clamp is configured to reduce a lifting height required for loading the vessel to the vessel cart or unloading the vessel from the vessel cart.

3. The vessel cart of claim 1 further comprising:
a plurality of wheels connected to the base at a side of the base facing away from the clamp to facilitate moving of the vessel cart, wherein the plurality of wheels comprises:
one or more fixed wheels disposed at a rear side of the vessel cart; and
one or more swivel v-groove track wheels disposed at a front side of the vessel car.

4. The vessel cart of claim 1 further comprising:
a brake connected to the stand or the base and configured to selectively lock or unlock the vessel cart,
wherein the brake is a foot brake connected to the base at a side of the base facing away from the clamp.

5. The vessel cart of claim 1 further comprising:
one or more handles connected to or integrally formed with an upper portion of the stand to facilitate maneuvering of the vessel cart, wherein the one or more handles comprises:
a first pair of handles extending toward a rear side of the vessel cart; and
a second pair of handles extending toward a front side of the vessel cart.

6. The vessel cart of claim 5, wherein:
the handles of the second pair of handles are longer than the handles of the first pair of handles;
the handles of the second pair of handles are spaced apart from each other;
the handles of the first pair of handles are spaced apart from each other; and/or
a distance between the handles of the second pair of handles is greater than a distance between the handles of the first pair of handles.

7. The vessel cart of claim 1, wherein the stand comprises:
a first bar and a second bar spaced apart from each other,
wherein the first and second bars are substantially perpendicular to the first surface of the base facing the clamp.

8. The vessel cart of claim 7, wherein the stand further comprises:
a cross member connected to or formed with upper portions of the first and second bars, wherein the clamp is connected to the cross member of the stand.

9. The vessel cart of claim 1, wherein the first surface of the base facing the clamp is substantially planar.

10. The vessel cart of claim 1, wherein the base comprises a restriction member configured to limit movement of the lower portion of the vessel on the base.

11. The vessel cart of claim 10, wherein the restriction member comprises a raised rim on the first surface of the base facing the clamp, a dent recessed from the first surface of the base facing the clamp, an opening formed on the first surface of the base facing the clamp, or any combination thereof.

12. The vessel cart of claim 1, wherein the base comprises:
a first base member; and
a second base member disposed below and connected to the first base member,
wherein the first base member has an opening to allow the lower portion of the vessel to pass through and seat on the second base member.

13. The vessel cart of claim 12, wherein the opening of the first base member of the base is substantially planar and substantially circular.

14. The vessel cart of claim 12, wherein the second base member of the base comprises:
a rib disposed or formed on a surface of the second base member facing the first base member,
wherein the rib on the second base member and an edge of the opening of the first base member collectively limits movement of the lower portion of the vessel on the base when the vessel is loaded to the vessel cart.

15. The vessel cart of claim 14, wherein the rib is either curved or substantially straight.

16. The vessel cart of claim 1, wherein the clamp is removably connected to the stand, and wherein the clamp comprises:
a first clamp member connected to the stand;
a second clamp member pivotally connected to the first clamp member and rotatable with respect to the first clamp member in the plane substantially parallel to the first surface of the base; and
a third clamp member disposed at the first or second clamp member and configured to selectively lock or unlock the second clamp member with respect to the first clamp member.

17. The vessel cart of claim 1, wherein the clamp is configured to facilitate mounting of a headplate on the clamp, and
wherein the clamp comprises a plurality of fastening members each extending upward for connecting the headplate with the clamp, and wherein the plurality of fastening members is distributed substantially evenly along a perimeter of the clamp.

18. A vessel cart, comprising:
a stand comprising a first bar and a second bar spaced apart from each other, wherein each of the first and second bars comprises a lower portion and an upper portion;
a first pair of handles, one handle in the first pair of handles connected to or integrally formed with the upper portion of the first bar and the other handle in the first pair of handles connected to or integrally formed with the upper portion of the second bar;
a base connected to the lower portions of the first and second bars, wherein the base comprises a first base member and a second base member disposed below the first base member, wherein the first base member has an opening facing upward and configured to receive a lower portion of a vessel, and the second base member is connected to the first base member and configured to hold the vessel upright;
a clamp connected to the stand and configured to selectively grip an upper portion of the vessel; and
a plurality of wheels connected to a side of the base facing away from the clamp to facilitate moving of the vessel cart.

19. The vessel cart of claim 18, wherein each handle in the first pair of handles extends toward a rear side of the vessel cart.

20. The vessel cart of claim 19 further comprising:
a second pair of handles, one handle in the second pair of handles connected to or integrally formed with the upper portion of the first bar and the other handle in the second pair of handles connected to or integrally formed with the upper portion of the second bar, wherein each handle in the second pair of handles extends toward a front side of the vessel cart.

21. The vessel cart of claim 20, wherein a distance between the handles of the second pair is greater than a distance between the handles of the first pair.

22. A vessel assembly comprising:
a vessel cart of any claim 1; and
a headplate configured to be mounted on the clamp of the vessel cart, wherein the headplate comprises:
a groove formed at a lower side of the headplate to accommodate a sealing member, wherein the sealing member is an O-ring or a gasket.

23. The vessel assembly of claim 22 further comprising:
a vessel configured to be loaded into the vessel cart,
wherein the vessel is a reaction vessel for biomaterial processing.

24. The vessel assembly of claim 23, wherein the vessel has a sustainably cylindrical shape, a height ranging from 10 inches to 60 inches, and a nominal diameter ranging from 5 inches to 20 inches.

25. The vessel assembly of claim 22, wherein:
the clamp of the vessel cart comprises a plurality of fastening members extending upward; and
the headplate is fastened to the clamp by a plurality of knobs, each tighten on a corresponding fastening member in the plurality of fastening members.

26. The vessel assembly of claim 22, wherein the vessel assembly has a width ranging from 12 inches to 24 inches, a height ranging from 22 inches to 42 inches, and a depth ranging from 19 inches to 36 inches.

27. The vessel assembly of claim 22, wherein the vessel assembly is configured to fit in a sink, a dishwasher, an autoclave or an upstream processing module of a biomanufacturing system.
